(19) United States
(12) Patent Application Publication
(10) Pub. No.: US 2019/0160834 A1
(43) Pub. Date: May 30, 2019

(54) PRINTER AND PRINTING METHOD

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 16/183,753

(22) Filed: Nov. 8, 2018

(30) Foreign Application Priority Data
Nov. 30, 2017 (JP) 2017-230056

(51) Int. Cl. B41J 11/00

(52) U.S. Cl. CPC B41J 11/0045

(57) ABSTRACT

Disclosed is a printer that performs inkjet printing, and the printer includes an inkjet head and a medium transport unit. In this printer, the medium transport unit has an electrostatic adsorption belt which is an adsorption member that electrostatically adsorbs a medium and a charging member that charges at least a portion of the electrostatic adsorption belt. The charging member has a unipolar charging section that charges a head facing region of the electrostatic adsorption belt and a bipolar charging section that charges a non-facing region that is at least a portion of a portion other than the head facing region of the electrostatic adsorption belt. The unipolar charging section charges the head facing region such that a region facing the inkjet head on a surface of the medium is charged to either a positive or a negative polarity, and the bipolar charging section bipolarly charges the non-facing region.

### CROSS REFERENCE TO RELATED APPLICATIONS

This application claims the priority benefit of Japanese Patent Application No. 2017-230056, filed on Nov. 30, 2017. The entirety of the above-mentioned patent application is hereby incorporated by reference herein and made a part of this specification.

### TECHNICAL FIELD

The present disclosure relates to a printer and a printing method.

### DESCRIPTION OF THE BACKGROUND ART

In the related art, inkjet printers for performing printing in an inkjet scheme are widely used. In the inkjet printers, media of various materials can be used as media to be printed. For example, in the related art, a configuration in which printing is performed for a fabric medium with an inkjet printer is known (see, for example, Japanese Unexamined Patent Publication No. 2017-65076).

### SUMMARY

When printing is performed in an inkjet printer, for example, a position facing an inkjet head in a medium is sequentially changed by transporting the medium. As a method of transporting the medium, for example, the method of transporting the medium in a predetermined transport direction using a roller or the like is widely used. However, depending on the type of the medium, it may be difficult to suitably transport the medium merely by using the roller or the like. More specifically, for example, in a configuration (textile printer) in which printing is performed for a fabric medium, since the medium is likely to be deformed, at times it is not able to transport the medium with high accuracy merely by transporting the medium with a roller or the like. Thus, in such a case, an adhesive transport method may be used, for example. The adhesive transport method refers to, for example, a method of transporting a fabric medium (cloth or the like) applied on a belt (adhesive belt) coated with an adhesive.

However, in this case, it is conceivable that an adhesive force of the adhesive of the adhesive belt decreases due to the influence of, for example, attachment of fiber debris and dust generated from the fabric medium. Thus, in the case of using the adhesive transport method, it is usually necessary to replace the adhesive at regular intervals, which may reduce work efficiency. Further, in this case, since a solvent odor is generated during application of the adhesive, measures such as performing ventilation and prohibiting entry by non-workers are required. As a result, it is conceivable that a decrease in work efficiency or deterioration of work environment is caused.

Further, as a method of transporting the fabric medium or the like, for example, a method of transporting the medium adsorbed by electrostatic adsorption (electrostatic adsorption method) can be considered. In this case, for example, it is conceivable that the medium is adsorbed by a bipolar charge adsorption method so that the charged electric charge is hardly left on the cloth and adsorption efficiency is improved. The bipolar charge adsorption method is, for example, a method in which adsorption is performed by a configuration in which positive and negative charged portions are alternately generated along a medium transport direction.

However, in this case, it is conceivable that a landing position of ink (ink droplets) is disturbed due to the influence of charging of the medium. More specifically, in the case of using the bipolar charge adsorption method, since positive and negative bipolar charges induced by a bipolar line electric field generated in a member that adsorbs a medium are distributed on a surface of the medium, even though the surface of the medium is electrically neutral as a whole, polarization divided into a positively charged region and a negatively charged region microscopically occurs in a direction parallel to the surface of the medium. In this case, the microscopic occurrence of polarization means that, for example, the medium is bipolarly charged so that polarization occurs on the medium in units of a range larger than the diameter of ink droplets and the like. In addition, in this case, it is also conceivable that a fluctuating potential moving at the medium transporting speed occurs as the medium is transported. In the case of droplets of small-volume ink droplets to be ejected in an inkjet scheme, the trajectory of the ink droplets flying changes due to such a slight polarization or the like, so that the landing position tends to be disturbed. As a result, it is conceivable that a quality of the image to be printed is deteriorated.

In addition, in this case, it is conceivable that disturbance of the landing position becomes larger if, for example, ink that tends to be charged is used. Thus, restrictions on usable ink may be increased in some cases. Regarding the structure of the inkjet head, if ejected ink tends to be charged, disturbance of the landing position is more likely to occur. For example, in the case of a share mode type of inkjet head in which ejected ink is in contact with an electrode in the inkjet head, an inkjet head in which a nozzle plate and a nozzle surface are formed of insulating materials, and the like, the above problem becomes significant, and disturbance of the landing position is likely to occur. For this reason, conventionally, it has been desired to transport a medium by a more suitable method. The present disclosure provides a printer and a printing method capable of solving the above-described problem.

In order to prevent the influence of microscopic polarization when a medium is transported by the electrostatic adsorption method, it seems to be enough to charge the medium such that the surface of the medium has only one of positive and negative polarities without using the bipolar charge adsorption method. However, in this case, since a charged state occurs while the polarity of the entire surface of the medium greatly biases, various problems may occur. More specifically, for example, it is conceivable that the electrostatic force applied to the entire medium becomes large and the medium adsorbs to an unintended portion. In addition, it is also conceivable that the medium is likely to suck dust and the like therearound.

On the other hand, the inventor of this application has considered that only a region facing the inkjet head on the surface of the medium is charged to one polarity and other regions are bipolarly charged. With this configuration, it is possible to suitably prevent occurrence of microscopic polarization in, for example, the region facing the inkjet head on the surface of the medium. In addition, consequently, it is possible to suitably prevent occurrence of disturbance of the landing position of ink, for example. In this case, by bipolarly charging a portion of the medium other than the region facing the inkjet head, the entire surface of the medium can be brought into a state of being electrically neutral or nearly neutral. Thus, with this configuration, for example, the medium can be more suitably transported by using the electrostatic adsorption method. Further, by more earnest researches, the inventor of this application found the features necessary for obtaining such effects, and thus completed the present disclosure.

In order to solve the above problems, the present disclosure provides a printer that performs inkjet printing for a medium. This printer includes an inkjet head that ejects ink by an inkjet scheme and a medium transport unit that transports the medium in a preset transport direction while adsorbing the medium by electrostatic adsorption. In this printer, the medium transport unit has an adsorption member that electrostatically adsorbs the medium due to charging of at least one portion and a charging member that charges at least a portion of the adsorption member, the charging member has a unipolar charging section that charges a head facing region, which is a region facing the inkjet head, in the adsorption member and a bipolar charging section that charges a non-facing region that is at least a portion of a portion other than the head facing region in the adsorption member, the unipolar charging section charges the head facing region such that a region facing the inkjet head on a surface of the medium is charged to either a positive or a negative polarity, and the bipolar charging section charges the non-facing region such that a portion charged by the bipolar charging section on the surface of the medium is charged to bipolarity including a positively charged portion and a negatively charged portion.

In such a configuration, for example, when the head facing region in the adsorption member is charged by the unipolar charging section of the charging member, it is possible to suitably prevent microscopic polarization from occurring in the region facing the inkjet head on the surface of the medium. In addition, consequently, it is possible to suitably prevent occurrence of disturbance of the landing position of ink, for example. Further, in this case, the non-facing region in the adsorption member is charged by the bipolar charging section of the charging member, so that the entire surface of the medium can be brought into a state of being electrically neutral or nearly neutral. Thus, with this configuration, for example, the medium can be more suitably transported by using the electrostatic adsorption method.

In this configuration, as the adsorption member, a member (for example, an electrostatic adsorption belt or the like) that moves in a state of adsorbing the medium by electrostatic adsorption to move the medium can be suitably used, for example. As the medium, a fabric medium or the like can be suitably used. With this configuration, for example, the fabric medium can be suitably transported. Further, as the medium, a medium other than a fabric may be used. In this configuration, the inkjet head has, for example, a plurality of nozzles. In this case, it is preferable to set a width of the head facing region according to the range where the nozzle exists. More specifically, for example, when a width in the transport direction of the range where the plural nozzles of the inkjet head are arranged is defined as a nozzle range width, the width of the head facing region in the transport direction is preferably not less than 0.9 times and not more than twice the nozzle range width. With this configuration, it is possible to more suitably prevent occurrence of disturbance of the landing position of ink, for example. It is more preferable that the width of the head facing region in the transport direction be not less than the nozzle range width. In this case, it is conceivable that the width of the head facing region in the transport direction is, for example, approximately 1 to 1.5 times the nozzle range width.

With respect to a portion bipolarly charged on the surface of the medium, if a cycle of polarity reversal is large, influence of unbalanced charge is liable to occur in some cases. Thus, it is preferable to sufficiently shorten the cycle of polarity reversal. More specifically, it is preferable that the cycle of polarity reversal being shorter than the width of a head facing region portion in the transport direction, for example. In this case, the bipolar charging section of the charging member, for example, bipolarly charges the surface of the medium such that the polarity is reversed at intervals shorter than the width of the head facing region in the transport direction. In this case, the cycle of polarity reversal is, for example, the width in the transport direction of the range charged to the same polarity. The cycle of polarity reversal is preferably not more than ½, more preferably not more than ¼, of the width of the head facing region portion in the transport direction. With this configuration, it is possible to more suitably prevent the influence of unbalanced charge on the medium, for example.

In this configuration, a printer may further include a static eliminator. In this case, for example, the static eliminator removes static electricity from the medium on a downstream side of the inkjet head in the transport direction. In this case, the removal of static electricity from the medium means, for example, removal of unevenly charged charges (residual charge) in the medium. With this configuration, for example, even when the medium is unevenly charged to a positive or a negative polarity, the influence of charging can be suitably removed. In this configuration, for example, it is conceivable that the ink is charged to a polarity opposite to the above positive or negative polarity to fly the ink more suitably. In this case, the inkjet head ejects the ink charged to the polarity opposite to the above positive or negative polarity. In such a configuration, the ink being flying will receive electrostatic force in a direction toward the medium. Thus, with this configuration, for example, it is possible to assist a flight of the ink and suitably prevent the ink from being misted. More specifically, in this case, it is conceivable that the medium is charged to the positive polarity and the ink is negatively charged.

In this case, it is preferable that a printer 10 further include a head potential adjustment unit. The head potential adjustment unit is configured to adjust a potential of at least a portion of the inkjet head and generates an electric field, directed in such a direction that a force in a direction from the inkjet head toward the medium is applied to the charged ink, between the inkjet head and the medium. In this case, it is preferable to adjust the potential of the inkjet head such that a parallel electric field is formed from the inkjet head toward the medium. With this configuration, for example, the flight of ink droplets can be assisted by accelerating the ink droplets by the electric field. In addition, consequently, it is possible to more suitably prevent occurrence of disturbance of the landing position of ink, for example.

In such a configuration, for example, even when a distance (gap, gap length) between the inkjet head and the medium is large, the ink can be more suitably landed. More specifically, in this configuration, the gap may be not less than 10 mm. In this case, the case where the gap is not less than 10 mm means, for example, that the inkjet head ejects the ink while leaving a gap of not less than 10 mm from the medium. With this configuration, for example, even in the case of using a medium of a fabric having long hair or the like, it is possible to perform printing more suitably.

In order to make the gap larger, it is also conceivable, for example, to generate an airflow assisting the flight of the ink. In this case, the printer further includes, for example, a suction unit that sucks air at a position facing the inkjet head across the medium. As the medium, a medium through which a gas passes, such as a fabric medium, is used. If necessary, it is preferable to use a configuration allowing a gas to pass even as an adsorption member or the like. With this configuration, for example, even when the gap is larger, the ink can be more suitably landed. This also makes it possible, for example, to provide a printer with a larger gap, and the like. In this case, the gap may be not less than 15 mm, for example.

Further, as the configuration of the present disclosure, it is also conceivable to use a printing method or the like having the same characteristics as described above. Also in this case, for example, the same effect as the above can be obtained. This printing method can also be considered, for example, as a manufacturing method for printed matter.

According to the present disclosure, the medium can be transported more suitably.

### BRIEF DESCRIPTION OF THE DRAWINGS

FIG. 1 is a diagram illustrating an example of a configuration of a main portion of a printer 10 according to an embodiment of the present disclosure;

FIGS. 2A to 2C are diagrams for explaining in more detail a configuration of an inkjet head 12, a manner of charging an electrostatic adsorption belt 102, and the like, wherein FIG. 2A illustrates an example of a more detailed configuration of the inkjet head 12, FIG. 2B is a diagram for explaining a configuration of a charging member 104 in more detail, and FIG. 2C illustrates the charging member 104 together with the electrostatic adsorption belt 102; and

FIG. 3 is a diagram for explaining a modification of the configuration of the printer 10.

### DETAILED DESCRIPTION OF EMBODIMENTS

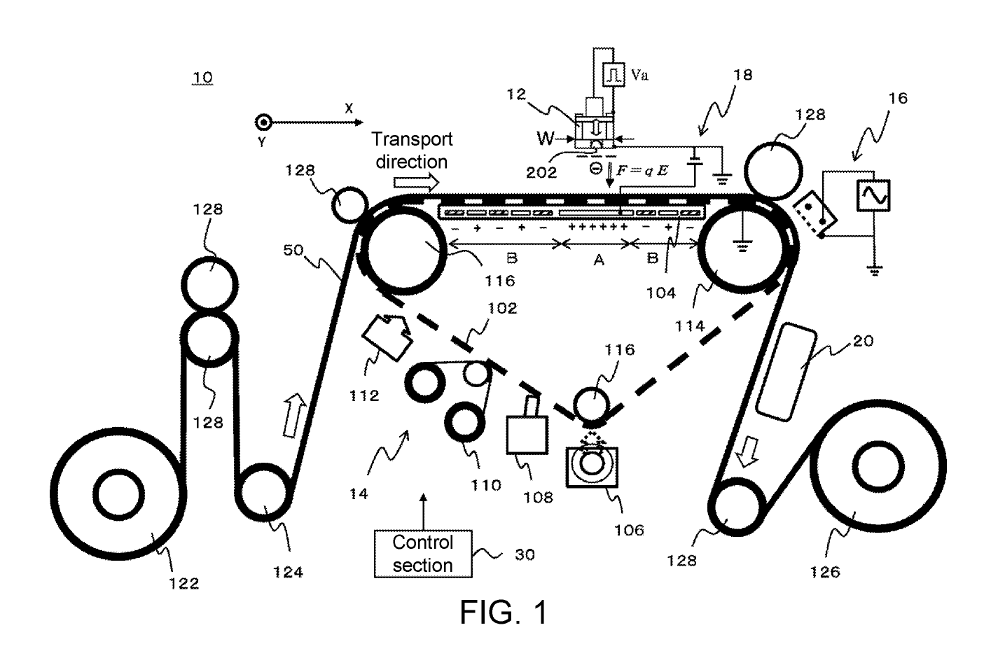

Hereinafter, embodiments according to the disclosure will be described with reference to the drawings. FIG. 1 illustrates an example of a configuration of a main portion of a printer 10 according to an embodiment of the present disclosure. In this example, the printer 10 is an inkjet printer (electrostatic adsorption fabric transport method textile printer) that performs inkjet printing for a fabric medium (medium) 50 such as a fabric, and includes an inkjet head 12, a medium transport unit 14, a static eliminator 16, a head potential adjustment unit 18, a post-drying section 20, and a control section 30.

Except for the additional features described below, the printer 10 may be identical or similar to well-known printers. Moreover, in addition to the structure illustrated, the printer 10 may be identical or similar to well-known printers. Further, in this example, the printer 10 is a serial inkjet printer that prompts the ink jet head 12 to perform a main scan operation. In this case, the main scan operation refers to an operation in which ink is ejected while moving in a preset main scanning direction. Furthermore, in this example, the main scanning direction is a direction parallel to a Y axis direction illustrated in the drawing. For example, the printer 10 performs printing in a multi-pass mode for performing multiple times of the main scan operation on each position of the medium 50.

The inkjet head 12 is an ejection head that ejects ink by an inkjet scheme. In this example, the inkjet head 12 has a nozzle plate formed with a nozzle 202 which is a fine hole, and the nozzle plate is disposed in a direction facing the medium 50. Consequently, the inkjet head 12 ejects the ink (ink droplets) from the nozzle 202 toward the medium 50. As the inkjet head 12, for example, a piezo type inkjet head or the like can be suitably used. In this case, the inkjet head 12 ejects the ink from the nozzle 202 in accordance with a pulsed drive signal indicated as Va in the drawing, for example.

As the ink ejected from the inkjet head 12, it is conceivable to suitably use known ink that can be printed on a fabric. As such ink, for example, it is possible to suitably use evaporation drying type ink that is fixed to the medium 50 by drying a solvent. In this case, it is preferable that the printer 10 further include a heater or the like for drying the ink. For example, the heater is disposed at a position facing the inkjet head 12 across the medium 50. In this example, the nozzle plate of the inkjet head 12 is a conductive nozzle plate. As a result, at least a nozzle surface of the inkjet head 12 is electrically conductive. Further, in this example, a potential of the nozzle plate of the inkjet head 12 is set to ground potential by the head potential adjustment unit 18, as illustrated in the drawing. As will be described in more detail later, in this example, ink capable of being charged to a negative polarity (negative charging) is used as the ink. Consequently, the inkjet head 12 ejects a negatively charged ink toward the medium 50.

In FIG. 1, for simplicity of illustration, only one nozzle 202 is illustrated for the nozzles 202 of the inkjet head 12. However, as will be described in more detail later, the inkjet head 12 of this example has a plurality of the nozzles 202. In this case, for example, the inkjet head 12 has the nozzles 202 within a range of a width of the inkjet head 12 indicated as the width W in the drawing. In FIG. 1, only one inkjet head 12 is illustrated as the inkjet head 12 included in the printer 10. However, the printer 10 may include a plurality of the inkjet heads 12. In this case, for example, the printer 10 includes the inkjet heads 12 that eject inks of different colors, respectively. More specifically, in this case, it is conceivable to use the inkjet heads 12 for Y, M, C, and K colors, for example. If necessary, inkjet heads 12 for R, G, and B colors or ink-jet heads 12 for special colors, such as white, a clear color, and a metallic color may be further used. As described above, in this example, the potential of the nozzle plate is adjusted to the ground potential by using the inkjet head 12 having the conductive nozzle plate. However, a specific configuration of the inkjet head 12 is not limited to such a configuration, and various modifications are possible. In this case, for example, it is possible to suitably use the inkjet head 12 having the nozzle surface formed of metal, or the inkjet head 12 having the nozzle surface formed of an insulating material having a conductive layer on the surface.

The medium transport unit 14 is a transport unit that transports the medium 50 in a preset transport direction. In this case, the transport direction is, for example, a direction along a preset transport path of the medium 50. In this example, the transport direction of the medium 50 at a position facing the inkjet head 12 is parallel to a sub scanning direction (an X axis direction illustrated in the drawing) orthogonal to the main scanning direction. The medium transport unit 14 has a configuration of transporting the medium 50 while adsorbing the medium 50 by electrostatic adsorption, and has an electrostatic adsorption belt 102, a charging member 104, a cleaning machine 106, a suction/wiping section 108, a wiping portion 110, a drying section 112, a driving roller 114, a plurality of driven rollers 116, a feeding roller 122, a tension load roller 124, a take-up roller 126, and a plurality of driven rollers 128.

The electrostatic adsorption belt 102 is an example of an adsorption member, and at least a portion thereof is charged to electrostatically adsorb the medium 50. Further, the electrostatic adsorption belt 102 moves in a state of adsorbing the medium 50 by electrostatic adsorption and thereby moves the medium 50 in the transport direction. More specifically, in this example, the electrostatic adsorption belt 102 is a dielectric belt (electrostatic adsorption dielectric belt) that can electrostatically adsorb the medium 50. As the electrostatic adsorption belt 102, for example, it is possible to suitably use a belt-shaped member that is the same as or similar to a known electrostatic adsorption belt used for bipolar electrostatic adsorption transportation. In FIG. 1, the electrostatic adsorption belt 102 is illustrated by a broken line for convenience of illustration. However, in the actual configuration, as the electrostatic adsorption belt 102, a belt-shaped member continuously connected can be suitably used.

The charging member 104 is a member for charging at least a portion of the electrostatic adsorption belt 102. In this example, the charging member 104 charges a head facing region and a non-facing region of the electrostatic adsorption belt 102, which are regions indicated by arrows A and B in the drawing, to adsorb the medium 50 to the electrostatic adsorption belt 102. In this case, the head facing region of the charging member 104 is a region facing the inkjet head 12 in the electrostatic adsorption belt 102 as indicated by the arrow A in the drawing. On the other hand, the non-facing region of the charging member 104 is a region adjacent to the head facing region in the transport direction as indicated by the arrow B in the drawing. Regarding the non-facing region, for example, it can be considered as at least a portion of a portion other than the head facing region of the electrostatic adsorption belt 102.

In this example, in the charging member 104, the head-facing region and the non-facing region of the charging member 104 are charged such that a portion corresponding to the head facing region on the surface of the medium 50 is charged to a positive polarity (positively charged), and a portion corresponding to the non-facing region is bipolarly charged. In this case, the case where the surface of the medium 50 is bipolarly charged means performing charging such that, for example, a positively charged portion and a negatively charged portion are included. A manner of charging the electrostatic adsorption belt 102 will be described in more detail later.

The cleaning machine 106, the suction/wiping section 108, the wiping portion 110, and the drying section 112 are members for performing maintenance of the electrostatic adsorption belt 102 during printing operation. Among them, the cleaning machine 106 is configured to clean the electrostatic adsorption belt 102, and sprays a liquid such as a cleaning liquid to a portion of the electrostatic adsorption belt 102, which has passed through a position facing the inkjet head 12, to clean the electrostatic adsorption belt 102. The suction/wiping section 108 is configured to suck and wipe a portion of the electrostatic adsorption belt 102, which has passed through a position of the cleaning machine 106. The wiping portion 110 is configured to wipe a portion of the electrostatic adsorption belt 102, which has passed through a position of the suction/wiping section 108. The drying section 112 is configured to dry a portion of the electrostatic adsorption belt 102, which has passed through a position of the wiping portion 110. By using these configurations, for example, the electrostatic adsorption belt 102 can be cleaned during printing operation. In addition, consequently, for example, even when ink having passed through the medium 50 adheres to the electrostatic adsorption belt 102 at a time of passing through the position facing the inkjet head 12, the attached ink can be removed suitably.

The driving roller 114 and the plural driven rollers 116 are configured to move the electrostatic adsorption belt 102 along the transport direction. The driving roller 114 rotates in contact with the electrostatic adsorption belt 102 and thereby moves the electrostatic adsorption belt 102 along the transport direction. The plural driven rollers 116 are rollers in contact with the electrostatic adsorption belt 102 at a predetermined position, and rotate according to the movement of the electrostatic adsorption belt 102. With this configuration, for example, the electrostatic adsorption belt 102 can be suitably moved. In this case, the medium 50 electrostatically adsorbed to the electrostatic adsorption belt 102 also moves together with the electrostatic adsorption belt 102. Thus, according to this example, the medium 50 can be suitably transported by using the electrostatic adsorption belt 102.

Among the configurations of the medium transport unit 14, the feeding roller 122, the tension load roller 124, the take-up roller 126, and the plural driven rollers 128 are configured to transport the medium 50 together with the electrostatic adsorption belt 102. More specifically, in this example, as illustrated in the drawing, the printer 10 feeds the medium 50 wound in a roll shape to a position facing the inkjet head 12, and the medium 50 is wound on a downstream side of the inkjet head 12 in the transport direction. In this case, the medium 50 comes into contact with the electrostatic adsorption belt 102 in a portion of the transport path.

Further, in this case, the feeding roller 122, the tension load roller 124, the take-up roller 126, and the plural driven rollers 128 mainly transport the medium 50 at a position where the medium 50 and the electrostatic adsorption belt 102 do not come into contact with each other. For example, the feeding roller 122 is a roller that rotates a rolled medium, which is the medium 50 wound in a roll shape before printing, and feeds the medium 50 in sequence according to the progress of printing. The tension load roller 124 is a roller for applying a predetermined tension to the transported medium 50. The take-up roller 126 is a roller for winding the medium 50 on the downstream side of the inkjet head 12, and winds a printed portion of the medium 50 in sequence to wind the medium 50 on which printing has been completed. The plural driven rollers 128 are rollers in contact with the medium 50 at a predetermined position, and rotate according to the movement of the medium 50. With this configuration, in this example, the medium transport unit 14 transports the medium 50 while adsorbing the medium 50 by electrostatic adsorption.

The static eliminator 16 is configured to remove static electricity from the medium 50. The removal of static electricity from the medium 50 means, for example, removal of unevenly charged charges (residual charge) in the medium 50. In this example, the static eliminator 16 is disposed on the downstream side of the inkjet head 12 in the transport path of the medium 50, and removes static electricity from the medium 50. With this configuration, for example, even when the medium 50 is unevenly charged to a positive or a negative polarity, residual charge can be suitably erased. In addition, consequently, for example, it is possible to suitably remove the influence of charging. More specifically, as described above, in this example, the portion corresponding to the head facing region on the surface of the medium 50 is positively charged. In this case, there is also a possibility that the medium 50 is unevenly charged to a positive polarity on the downstream side of the inkjet head 12. On the other hand, according to this example, it is possible to suitably remove the influence of such charging. As the static eliminator 16, a known static eliminator can be suitably used. More specifically, as the static eliminator 16, for example, it is possible to suitably use a shield type static eliminator that can automatically select and extract positive and negative ions opposite to the polarity of the electric charge charged in the medium 50 serving as a counterpart of static elimination. As the static eliminator 16, for example, a corona discharge type static eliminator or the like that generates a corona wire can be suitably used.

The head potential adjustment unit 18 is configured to adjust the potential of at least a portion of the inkjet head 12. More specifically, as described above, in this example, the head potential adjustment unit 18 adjusts the potential of the nozzle plate in the inkjet head 12 to the ground potential. The reason why the potential is adjusted by using the head potential adjustment unit 18 will be described in more detail later.

The post-drying section 20 is a heater that heats the medium 50 on the downstream side of the inkjet head 12. As the post-drying section 20, for example, an infrared heater or the like can be suitably used. By virtue of the use of the post-drying section 20, it is possible to sufficiently dry the ink by, for example, heating the medium 50 which has undergone the process of ejecting the ink by the inkjet head 12 and the process of static elimination by the static eliminator 16. Consequently, it is possible to more suitably fix the ink to the medium 50. In this case, the ink is sufficiently dried, whereby it is possible to more suitably wind the medium 50 on the take-up roller 126.

The control section 30 is a controller that controls each part of the printer 10. According to this example, it is possible to suitably perform printing for the fabric medium 50. In addition, by using the electrostatic adsorption belt 102 or the like, the medium 50 can be suitably transported by the electrostatic adsorption method.

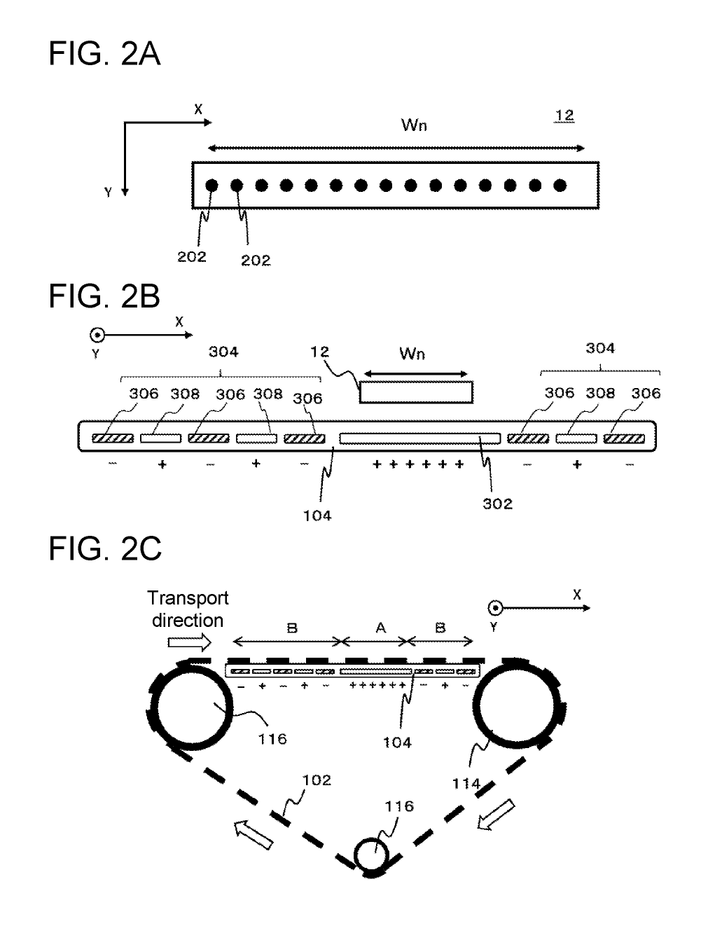

Next, the manner of charging the electrostatic adsorption belt 102 by the charging member 104 and the like will be described in more detail. FIGS. 2A to 2C are diagrams for explaining in more detail a configuration of the inkjet head 12 used in this example, the manner of charging the electrostatic adsorption belt 102, and the like. FIG. 2A illustrates an example of a more detailed configuration of the inkjet head 12,

As described above, in this example, the inkjet head 12 has the plurality of nozzles 202. The plurality of nozzles 202 are arranged in a nozzle row direction parallel to the sub scanning direction (X axis direction) to form a nozzle row as illustrated in the drawing, for example. In the following description, a width in the sub scanning direction of the range where the nozzles of the inkjet head 12 exist is defined as a nozzle range width Wn. The nozzle range width Wn can be considered as, for example, a length of the nozzle row in the inkjet head 12. Further, the nozzle range width Wn can be considered as, for example, a width in the transport direction of the range where the plurality of nozzles 202 of the inkjet head 12 are arranged. As described above, in this example, the portion corresponding to the head facing region on the surface of the medium 50 is positively charged. In this case, it is preferable to set the head facing region according to the nozzle range width Wn.

FIGS. 2B and 2C are diagrams for explaining in more detail the manner of charging the electrostatic adsorption belt 102 by the charging member 104 and the like. FIG. 2B is a diagram for explaining the configuration of the charging member 104 in more detail and illustrates an enlarged view of the charging member 104 illustrated in FIG. 1 together with the inkjet head 12. FIG. 2C is a diagram illustrating the electrostatic adsorption belt 102 and the charging member 104, and illustrates a portion of the configuration illustrated in FIG. 1 by extracting from FIG. 1. In this example, the charging member 104 has a unipolar charging section 302 and a plurality of bipolar charging sections 304. The unipolar charging section 302 is a section for charging the head facing region of the electrostatic adsorption belt 102, is disposed at a position facing the inkjet head 12 across the electrostatic adsorption belt 102, and is charged to a predetermined polarity to charge the head facing region of the electrostatic adsorption belt 102. In this case, the unipolar charging section 302 charges itself to either a positive or a negative polarity, so that the head facing region is charged such that the region facing the inkjet head 12 on the surface of the medium 50 is charged to either a positive or a negative polarity. More specifically, in this example, the unipolar charging section 302 is constituted of one electrode, and the unipolar charging section 302 is positively charged as illustrated in the drawing, so that the head facing region is charged such that the region facing the inkjet head 12 on the surface of the medium 50 is positively charged. In addition, in this example, as described above, the potential of the nozzle plate constituting the nozzle surface of the inkjet head 12 is set to the ground potential. In this case, positive charging means, for example, positive charging with reference to the potential of the nozzle surface. Further, in this case, the unipolar charging section 302 can be considered as, for example, a zone (positive voltage application zone) where only a non-bipolar positive voltage is applied. Further, in this case, the head facing region of the electrostatic adsorption belt 102 charged according to the state of the unipolar charging section 302 may be considered as, for example, a zone (positive electrostatic adsorption zone) where electrostatic adsorption is performed by positive charging. The positive electrostatic adsorption zone can be considered as, for example, a zone where electrostatic adsorption is performed by positive charging in the range of the print width of the inkjet head 12. Furthermore, in this case, it is preferable to set a width (width in the transport direction) of the unipolar charging section 302 according to the nozzle range width Wn. With this configuration, for example, the width of the head facing region can be suitably set.

Although not illustrated, it is preferable that the width of the unipolar charging section 302 in the main scanning direction be set in accordance with a main scanning width Ws which is a width at which the inkjet head 12 moves during main scan operation. In this case, the main scanning width Ws is a width in the main scanning direction of the range where the inkjet head 12 can eject ink by one main scan operation. More specifically, it is conceivable to set the width in the main scanning direction of the unipolar charging section 302 to such a width that the width in the main scanning direction of the head facing region of the electrostatic adsorption belt 102 is not less than Ws. With this configuration, for example, it is possible to suitably provide the positive electrostatic adsorption zone having an area larger than an area Ws×Wn where ink is ejected in one main scan operation. In addition, consequently, for example, it is possible to suitably apply a positive voltage to a range corresponding to the entire positive electrostatic adsorption zone on the surface of the medium 50.

The plural bipolar charging sections 304 are portions for charging the non-facing region of the electrostatic adsorption belt 102, are arranged at positions adjacent to the unipolar charging section 302 on each of the upstream and downstream sides in the transport direction, and charge themselves to charge the non-facing region of the electrostatic adsorption belt 102. In this case, the bipolar charging section 304 charges the non-facing region so that the portion charged on the surface of the medium 50 by the bipolar charging section 304 is charged bipolarly. The bipolar charging means the case where each configuration is charged such that a positively charged portion and a negatively charged portion are included and bipolar electrostatic adsorption is possible.

More specifically, in this example, each of the bipolar charging sections 304 has a plurality of electrodes 306 and 308 aligned along the transport direction. In this case, the electrode 306 is negatively charged, as illustrated in the drawing. On the other hand, the electrode 308 is positively charged. With this configuration, for example, the non-facing region of the electrostatic adsorption belt 102 can be suitably bipolarly charged. In such a configuration, the bipolar charging section 304 can be considered as, for example, a zone (bipolar voltage application zone) where a bipolar voltage is applied on both sides of the unipolar charging section 302 in the transport direction. Further, the bipolar charging section 304 can be considered as, for example, a zone where the negative electrodes 306 and the positive electrodes 308 are alternately arranged. Further, in this case, the non-facing region of the electrostatic adsorption belt 102 charged according to the state of the bipolar charging section 304 can be considered as, for example, a zone (bipolar electrostatic adsorption zone) where electrostatic adsorption is performed by bipolar charging. The bipolar electrostatic adsorption zone can be considered as, for example, a zone where electrostatic adsorption is performed alternately with positive and negative polarities while changing positions in regions on both sides of the positive electrostatic adsorption zone in the transport direction.

In such a configuration, for example, when the head facing region of the electrostatic adsorption belt 102 is charged by the unipolar charging section 302 of the charging member 104, it is possible to suitably prevent microscopic polarization from occurring in the region facing the inkjet head 12 on the surface of the medium 50. In this case, the case where the microscopic polarization occurs in the region facing the inkjet head 12 on the surface of the medium 50 means, for example, that a positively charged portion and a negatively charged portion are generated at a level at which an accuracy of a landing position of ink is affected in a plane parallel to the surface of the medium 50. According to this example, occurrence of such microscopic polarization is prevented, so that, for example, it is possible to suitably prevent occurrence of disturbance of the landing position of ink. Further, in this case, the non-facing region of the electrostatic adsorption belt 102 is charged by the bipolar charging section 304 of the charging member 104, so that the entire surface of the medium 50 can be brought into a state of being electrically neutral or nearly neutral. Thus, according to this example, for example, the medium 50 can be suitably transported by the electrostatic adsorption method while suitably preventing disturbance of the landing position of ink.

Subsequently, supplementary explanations on the respective configurations described above, explanation of a modification, and the like are performed. As described above, the medium transport unit 14 (see FIG. 1) of this example transports the medium 50 by further using the feeding roller 122, the take-up roller 126, and so on (see FIG. 1) in addition to the electrostatic adsorption belt 102. In this case, the medium 50 is first unwound from the feeding roller 122 and sent to the position of the electrostatic adsorption belt 102. The medium 50 that has reached the electrostatic adsorption belt 102 is electrostatically adsorbed in the head facing region and the non-facing region of the electrostatic adsorption belt 102, which are the bipolar electrostatic adsorption zone and the positive electrostatic adsorption zone. Then, the electrostatic adsorption belt 102 is moved by the driving roller 114 to move the medium 50 together with the electrostatic adsorption belt 102. In this case, the electrostatic adsorption belt 102 and the medium 50 are moved between respective main scan operations performed in a multi-pass mode (multi-pass scan), thereby intermittently transporting the medium 50. The medium 50 having passed through the position facing the inkjet head 12 is wound by the take-up roller 126. According to this example, a fabric medium such as a fabric can be suitably transported.

In addition, in order to suitably prevent disturbance of the landing position of the ink, as described above, it is preferable to set the width of the head facing region of the electrostatic adsorption belt 102 according to the nozzle range width Wn. In this case, the width of the head facing region is a width of a region charged by the unipolar charging section 302 of the charging member 104. More specifically, it is preferable that the width of the head facing region in the transport direction of the medium 50 be not less than 0.9 times and not more than twice the nozzle range width Wn. With this configuration, it is possible to more suitably prevent occurrence of disturbance of the landing position of ink, for example. It is more preferable that the width of the head facing region in the transport direction be not less than the nozzle range width Wn. For example, it is conceivable that the width of the head facing region in the transport direction is approximately 1 to 1.5 times the nozzle range width Wn. It is more preferable that the width of the head facing region in the transport direction be not less than 1.1 times the nozzle range width Wn.

In this example, the medium 50 is adsorbed by bipolar electrostatic adsorption at a front and a rear in the transport direction of the region facing the inkjet head 12. In this case, as the bipolar charging section 304 of the charging member 104 is bipolarly charged, the surface of the medium 50 is also bipolarly charged. In this case, with respect to a portion bipolarly charged on the surface of the medium 50, if a cycle of polarity reversal is large, influence of unbalanced charge is liable to occur in some cases. The cycle of polarity reversal is, for example, the width in the transport direction of the range charged to the same polarity. Thus, for example, it is preferable that the cycle of polarity reversal be sufficiently shortened so that the medium 50 is substantially electrically neutral. More specifically, it is preferable that the cycle of polarity reversal be shorter than the width of a head facing region portion in the transport direction, for example. In this case, the bipolar charging section 304 of the charging member 104, for example, bipolarly charges the surface of the medium 50 such that the polarity is reversed at intervals shorter than the width of the head facing region in the transport direction. The cycle of polarity reversal is preferably not more than ½, more preferably not more than ¼, of the width of the head facing region portion in the transport direction. With this configuration, it is possible to more suitably prevent the influence of unbalanced charge on the medium 50, for example.

As described above, in this example, the ink ejected from the inkjet head 12 is negatively charged. The potential of the nozzle plate of the inkjet head 12 is adjusted to the ground potential by the head potential adjustment unit 18 (see FIG. 1). In this case, an electric field directed in such a direction that a force in a direction from the inkjet head 12 toward the medium 50 is applied to the charged ink is generated between the inkjet head 12 and the medium 50. In this case, it is preferable that the head potential adjustment unit 18 adjust the potential of the inkjet head 12 or the like such that a parallel electric field (electrostatic parallel electric field) is formed from the inkjet head 12 toward the medium 50. With this configuration, for example, it is possible to accelerate ink droplets that fly toward the medium 50 in the positive electrostatic adsorption zone. In addition, consequently, it is possible to suitably prevent the ink from being misted, for example. In this case, the configuration of this example can be considered as, for example, a configuration in which the charged ink is accelerated in the positive electrostatic adsorption zone and the medium 50 is electrostatically adsorbed and transported in the bipolar electrostatic adsorption zone.

As described above, according to this example, for example, electrostatic adsorption transportation can be suitably performed while suitably preventing disturbance of the landing position of ink. In this case, by virtue of the use of the electrostatic adsorption transportation, for example even when the medium 50 such as a stretchable soft fabric is used, the medium 50 can be stably transported and wound while suitably preventing occurrence of meandering and wrinkling. As described above, in this example, the electrostatic adsorption belt 102 is charged such that both sides of the positive electrostatic adsorption zone are bipolar electrostatic adsorption zones. With this configuration, for example, in a portion other than the positive electrostatic adsorption zone, it is possible to minimize bias of electric charge charged on the transported medium 50. In addition, consequently, it is possible to more suitably reduce disturbance of the landing position.

In this case, for example, when the ink is charged as described above and a flight of the ink is assisted using electrostatic force, for example, it is possible to achieve widening of a gap which is a distance between the inkjet head 12 and the medium 50. More specifically, in a conventional configuration, if the gap is merely to be enlarged, a flight speed of the ink decreases before the ink reaches the medium 50 due to the influence of air resistance, and mist formation or the like is likely to occur. On the other hand, in this example, for example, when the ink droplets are charged as described above and the electric field assisting the flight of the ink droplets is generated, it is possible to make it difficult for the ink to be misted. This also makes it possible to set the gap to not less than 10 mm, for example. In this case, the case where the gap is not less than 10 mm means, for example, that the inkjet head 12 ejects the ink while leaving a gap of not less than 10 mm from the medium 50.

Thus, according to this example, for example, even when the medium 50 such as a fabric having long hair (fibrous hair) is used, occurrence of ejection failure due to contact of the hair with the inkjet head 12 is prevented, and it is possible to perform printing more suitably. In addition, consequently, for example, wide gap conditions capable of stably performing printing also for the medium 50 such as a fabric having long hair are suitably achieved, and it is possible to suitably provide a wide gap type printer. In this case, since it is difficult for the ink to be misted, even in the case of ejecting small capacity of ink droplets (small ink droplets) in the inkjet head 12, it is possible to cause the ink to more suitably reach the medium 50. Thus, according to this example, for example, it is possible to more suitably perform printing with a higher resolution (super resolution) than in the past.

Here, a manner of flying ink droplets in this example will be described in more detail. For the sake of convenience of explanation, a state of flight of ink droplets after ejection and the like will be described first when ink is ejected with the conventional configuration. When ink droplets are ejected by the inkjet scheme, approximately considering, it can be considered that a velocity V at which the ink droplets fly after ejection is subjected to air resistance proportional to the velocity V and decays with a decay time constant (velocity decay lifetime) τ. More specifically, in this case, assuming that an initial velocity of the ink is V0, a velocity V(t) is a velocity of the ink droplets obtained when time t has elapsed rapidly decelerates according to the following equation.

V(t)=V0 exp(−t/τ) (1)

When a volume of ink droplets is approximately 5 pL, the decay time constant τ in air is approximately not more than several milliseconds. When printing at a resolution of 1200 dpi is performed, the volume of ink droplets needs to be not more than approximately 6 pL. Thus, when printing at a resolution of 1200 dpi is performed, the decay time constant τ is considered to be approximately not more than several milliseconds. In this case, when an arrival distance until the velocity V becomes 1/e of V0 is roughly calculated by the equation (1), a distance over which ink droplets with a volume of approximately 6 pL can stably land on the medium is approximately 3 mm.

However, when printing is performed for the medium 50 such as a soft fabric having raised hair in a textile printer or the like, if the distance (gap) between the medium 50 and the inkjet head 12 is approximately 3 mm, the medium 50 tends to come into contact with the inkjet head 12, which may make it difficult to perform stable printing. Thus, in a textile printer or the like that needs to perform printing for various fabric media 50, it is desirable to perform high resolution printing while maintaining a gap of not less than 10 mm. In this regard, if the volume of ink droplets (droplet size) is increased, the arrival distance of the ink droplets can be increased in substantially proportion to a radius R of the ink droplet. However, in this case, the printable resolution decreases. For this reason, it is difficult to achieve both a wide gap and high resolution printing in the conventional configuration.

Further, in this regard, more specifically, air resistance (drag) Fr acting on droplets flying in air increases as the velocity V increases, as expressed by the following equation.

Fr=kV (2) (Stokes's law under low speed conditions with small Reynolds number)

or

Fr=kV2 (3) (Newton's law under high speed conditions)

On the other hand, a kinetic energy of ink droplets being flying is proportional to the cube of the radius R of the ink droplet (proportional to the mass). Thus, when the radius R and the kinetic energy are small (in the case of small droplets), the kinetic energy rapidly decreases, and the influence of the air resistance dominates. Thus, in such a case, it is conceivable that the flight speed decelerates rapidly, and, for example, the ink droplets are flowed by an airflow generated by the movement of the inkjet head 12, so that the landing is inaccurate. In this case, if the gap is too wide, the ink is misted before reaching the medium 50.

On the other hand, as described above, in this example, the negatively charged ink droplets are ejected in the positive electrostatic adsorption zone by using the inkjet head 12 having the conductive nozzle surface. With such a configuration, for example, with respect to drag caused by the air resistance expressed by the equations (2) and (3), a deceleration amount can be compensated by force applied from a parallel electric field, directed from the inkjet head 12 toward the medium 50, to the ink droplets negatively charged and ejected. In addition, consequently, for example, it is possible to prevent a decrease in velocity of ink droplets, and, even when the gap is large, the ink can be suitably landed on the medium 50. More specifically, in this case, for example, electric field strength is set to approximately 5×104 to 106 volt/m, so that it is possible to suitably compensate for such deceleration. For example, when the gap is approximately 10 mm, a positive voltage of approximately 500 to 10000 Volt (volts) is applied to the unipolar charging section 302 of the charging member 104, so that such conditions can be suitably realized. In this case, due to the effect of the electric field for compensating the flying speed of the ink droplets, for example, printing with a gap of not less than approximately 10 mm (wide gap printing) necessary for using the fabric medium 50 having long hair becomes possible.

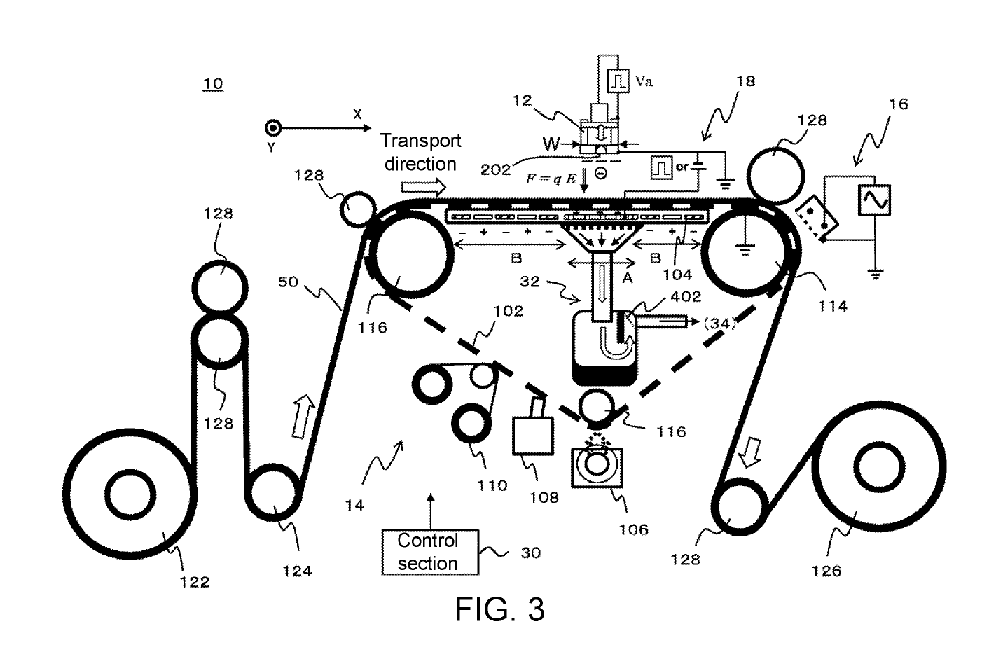

In order to make the gap larger and enable further widening of the gap, it is also conceivable, for example, to generate an airflow assisting the flight of the ink droplets. FIG. 3 is a diagram for explaining a modification of the configuration of the printer 10, and illustrates an example of a configuration of a main portion of the printer 10 in the case of generating the airflow assisting the flight of ink droplets.

Except for the additional features described below, the structural elements illustrated in FIG. 3 with the same reference signs as in FIGS. 1 and 2A to 2C may be identical or similar to the ones illustrated in FIGS. 1 and 2A to 2C. For convenience of illustration, in FIG. 3, a portion of the configuration of the printer 10 illustrated in FIG. 1 is omitted. However, in addition to the configuration illustrated in FIG. 3, the printer 10 according to this modification may further have the same or similar configuration as the printer 10 illustrated in FIG. 1, for example. The printer 10 of this modification may be considered as, for example, an electrostatic adsorption fabric transport method textile printer with an airflow added thereto.

Also in this modified example, as the medium 50, for example, a fabric medium 50 is used. In this case, the medium 50 may be considered as an example of an air permeable medium through which gas passes. In this example, the electrostatic adsorption belt 102 and the charging member 104 are members formed of an air permeable material. More specifically, as the electrostatic adsorption belt 102, for example, a porous dielectric belt, mesh belt, or the like can be suitably used. As the mesh belt, for example, a belt woven with plastic thread such as fluorine resin, polyester, nylon, or polyethylene thread or the like can be suitably used. In the charging member 104, a portion corresponding to the positive electrostatic adsorption zone is at least air permeable. In this case, for example, it is conceivable that a portion corresponding to the unipolar charging section 302 (see FIGS. 2A to 2C) in the charging member 104 is formed of, for example, an insulated electric wire mesh insulated and covered with plastic such as a permeable porous conductive film or fluororesin.

In this modification, the printer 10 further includes a suction unit 32 at a position facing the inkjet head 12 across the medium 50, the electrostatic adsorption belt 102, and the charging member 104. The suction unit 32 is an airflow generation unit that generates an airflow directed from the inkjet head 12 toward the medium 50, and suction is performed by a vacuum pump 34 to suck air on the back side of the medium 50. Further, in this modification, the suction unit 32 has a filter 402 and sends the sucked air to the vacuum pump 34 via the filter 402.

With such a configuration, for example, it is possible to suitably generate the airflow that assists the flight of ink droplets between the inkjet head 12 and the medium 50. In this case, for example, in addition to accelerating the ink droplets by the electric field between the inkjet head 12 and the medium 50, an airflow is generated, so that it is possible to more suitably prevent the deceleration of the ink droplets. More specifically, in this case, it is conceivable that the air resistance decreases as the ink droplets ride on the airflow. In this case, since the flight speed of the ink droplets is increased by a speed of the airflow, the ink may reach the medium 50 more quickly. In this case, it is possible to make the gap larger by a distance corresponding to an airflow speed ×τ obtained by multiplying the speed of airflow by the decay time constant τ. Thus, according to this modification, for example, even when the gap is larger compared with the case of performing printing without using such airflow, it is possible to more suitably land the ink and to suitably perform stable printing. In this case, the gap may be not less than 15 mm (for example, approximately several cm), for example. Further, according to this modification, for example, even when the gap is thus widened, it is possible to more suitably print a high-fineness image.

By virtue of the use of such airflow, for example, it is also possible to reduce the influence occurring when ink is misted. More specifically, when printing is performed with a large gap, for example, ink droplets are likely to be misted due to the influence of crosswind and the like generated as the inkjet head 12 moves. In this case, the medium 50 may be contaminated by landing of mist at an unintended position on the medium 50, dropping of mist adhered and accumulated around the inkjet head 12, and the like. On the other hand, in this modification, the generation of the airflow can suitably prevent mist from reaching an unintended portion, for example. In addition, consequently, it is possible to suitably prevent contamination of the medium 50 due to mist, for example. Thus, according to this modification, it is possible to more suitably perform stable printing under the wide gap conditions.

In addition, the feature of each part of the printer 10 can be further variously modified. For example, the ink used in the inkjet head 12 is not limited to the ink described above, and various inks may be used. In this case, it is conceivable to select the type of ink to be used, depending on the type of the medium 50, the purpose of printing, and the like. More specifically, as inks, various types of textile printing dyed inks and the like may be used. In this case, as a dye, for example, a sublimation dye, a disperse dye, a reactive dye, an acidic dye, a chemical dye, a natural dye, or the like may be used. A coloring material of ink is not limited to a specific coloring material, and pigments such as organic pigments and inorganic pigments can be used, for example. As described above, the color of ink to be used is not limited to a specific color. The manner of fixing ink (the principle of curing or fixing) is not limited particularly, and aqueous ink, UV ink, latex ink, solvent ink, SUV ink, or the like can be used. In this case, the SUV ink is, for example, UV ink diluted with a solvent. The inkjet head 12 is not limited to the piezo type inkjet head, and inkjet heads 12 of various types may be used. In this case, it is preferable to use an electrostatic charge inkjet head 12 capable of charging ink to a predetermined polarity (for example, negative polarity).

In the above description, the fabric medium 50 such as a fabric having long hair is mainly used as the medium 50. In this case, for example, it is conceivable to use the fabric medium 50 used for clothes. As the fabric medium 50, a long hair carpet or a towel cloth may be used, for example. The fabric medium 50 after processing, such as clothes, interior materials, curtains, or cover sheets, may be used. As the medium 50, a medium other than a fabric may be used. In this case, for example, it is conceivable to use various media 50 such as a film-like or plate-like medium. The medium is not limited to such a flat medium 50, and a medium 50 having large irregularities may be used, for example. Also in this case, by using a configuration with a large gap, printing can be suitably performed with high accuracy for various media 50. As such a medium 50, for example, a three-dimensional object such as a toy or various molded articles, a smartphone cover, or the like may be used. Besides that, it is also possible to suitably use the medium 50 or the like that requires printing of an image under the wide gap conditions, such as various products such as a cylindrical object and a polyhedron object.

The materials forming each part of the printer 10 are not limited to the configuration described above, and various modifications are possible. For example, with regard to the electrostatic adsorption belt 102, as long as the medium 50 such as a fabric can be electrostatically adsorbed and transported, changes in the material and the structure are not restricted. In this case, it is preferable to use a configuration that matches a specific configuration and the purpose of printing. More specifically, for example, it is preferable to use a configuration capable of generating an electric field that accelerates ink droplets ejected from the inkjet head 12. When the airflow passing through the medium 50 is generated, it is preferable to use a configuration that allows air to pass through.

The method of applying voltage to the positive electrostatic adsorption zone or the like can be variously changed. For example, in the above description, the configuration in which a direct voltage is always applied to the unipolar charging section 302 of the charging member 104 has been mainly described. However, as for the manner of applying voltage to the unipolar charging section 302, for example, a pulsed voltage may be applied to apply voltage in synchronization with ejection timing of ink droplets, or voltage may be applied superimposing on the flight time of the ink droplets. In this case, for example, the application of the voltage may be stopped during non-operation (time period when ink droplets are not ejected) where the printer 10 stops printing operation. A pulsed voltage may be applied to the bipolar charging section 304 of the charging member 104. Even in such a configuration, for example, the medium 50 can be suitably transported by the electrostatic adsorption method while suitably preventing disturbance of the landing position of ink.

In the above description, an example in which an electrostatic adsorption belt is used as an adsorption member has been mainly described. However, a member other than the electrostatic adsorption belt may be used as the adsorption member according to the quality required for printing, the type of the medium 50, and the like. In this case, not only a member that moves while adsorbing the medium 50 but also a member that performs only adsorption and does not move may be used. More specifically, as such an adsorption member, for example, a table-shaped member (for example, a platen) that supports the medium 50 on the upper surface at a position facing the inkjet head 12 may be used. In this case, the table-shaped member such as a platen may be considered as a constituent of the medium transport unit 14. In this case, it is conceivable that the medium 50 is transported by using, for example, a roller or the like in the medium transport unit 14. Also in such a configuration, for example, the unipolar charging section 302 is used at a position facing the inkjet head 12, so that it is possible to suitably prevent occurrence of disturbance of the landing position of ink. Also in this case, for example, the ink is charged, so that ink droplets can be accelerated by the electric field between the inkjet head 12 and the medium 50. In addition, in this case, the bipolar charging section 304 is used at a portion other than a position facing the inkjet head 12, whereby the entire surface of the medium 50 can be brought into a state of being electrically neutral or nearly neutral.

What is claimed is:

1. A printer that performs inkjet printing for a medium, comprising:
an inkjet head that ejects ink by an inkjet scheme; and
a medium transport unit that transports the medium in a preset transport direction while adsorbing the medium by electrostatic adsorption,
wherein the medium transport unit has
an adsorption member that electrostatically adsorbs the medium due to charging of at least one portion of the adsorption member and
a charging member that charges at least a portion of the adsorption member, the charging member has
a unipolar charging section that charges a head facing region, which is a region facing the inkjet head in the adsorption member and
a bipolar charging section that charges a non-facing region that is at least a portion of a portion other than the head facing region in the adsorption member,
the unipolar charging section charges the head facing region such that a region facing the inkjet head on a surface of the medium is charged to either a positive or a negative polarity, and
the bipolar charging section charges the non-facing region such that a portion charged by the bipolar charging section on the surface of the medium is charged to bipolarity including a positively charged portion and a negatively charged portion.

2. The printer according to claim 1, wherein the adsorption member moves in a state of adsorbing the medium by electrostatic adsorption to move the medium.

3. The printer according to claim 1, wherein the inkjet head has a plurality of nozzles, and
when a width in the transport direction of a range where the plurality of nozzles of the inkjet head are arranged is defined as a nozzle range width, and a width of the head facing region in the transport direction is not less than 0.9 times and not more than twice the nozzle range width.

4. The printer according to claim 1, wherein the bipolar charging section bipolarly charges the surface of the medium such that the polarity is reversed at intervals shorter than the width of the head facing region in the transport direction.

5. The printer according to claim 1, further comprising a static eliminator that removes static electricity from the medium on a downstream side of the inkjet head in the transport direction.

6. The printer according to claim 1, wherein the inkjet head ejects the ink charged to a polarity opposite to the positive or the negative polarity of the surface of the medium.

7. The printer according to claim 6, further comprising a head potential adjustment unit that adjusts a potential of at least a portion of the inkjet head to generate an electric field, directed in such a direction that a force in a direction from the inkjet head toward the medium is applied to the charged ink, between the inkjet head and the medium.

8. The printer according to claim 1, wherein the medium is a fabric medium.

9. The printer according to claim 1, wherein the inkjet head ejects the ink while leaving a gap of not less than 10 mm from the medium.

10. The printer according to claim 1, wherein the medium is a medium through which a gas passes, and
the printer further comprises a suction unit that sucks air at a position facing the inkjet head across the medium.

11. A printing method of performing inkjet printing for a medium, comprising:
ejecting ink from an inkjet head in an inkjet scheme; and
transporting, by a medium transport unit, the medium in a preset transport direction while adsorbing the medium by electrostatic adsorption,
wherein the medium transport unit has
an adsorption member that electrostatically adsorbs the medium due to charging of at least one portion of the adsorption member and
a charging member that charges at least a portion of the adsorption member,
the charging member has
a unipolar charging section that charges a head facing region, which is a region facing the inkjet head, in the adsorption member and
a bipolar charging section that charges a non-facing region that is at least a portion of a portion other than the head facing region in the adsorption member,
the unipolar charging section charges the head facing region such that a region facing the inkjet head on a surface of the medium is charged to either a positive or a negative polarity, and
the bipolar charging section charges the non-facing region such that a portion charged by the bipolar charging section on the surface of the medium is charged to bipolarity including a positively charged portion and a negatively charged portion.
